(19) United States
(12) Patent Application Publication
(10) Pub. No.: US 2021/0061292 A1
(43) Pub. Date: Mar. 4, 2021

(54) VEHICLE AND METHOD OF CONTROLLING THE SAME

(71) Applicants: HYUNDAI MOTOR COMPANY, Seoul (KR); KIA MOTORS CORPORATION, Seoul (KR)

(72) Inventor: Jungnam BAE, Seoul (KR)

(73) Assignees: HYUNDAI MOTOR COMPANY, Seoul (KR); KIA MOTORS CORPORATION, Seoul (KR)

(21) Appl. No.: 16/783,292

(22) Filed: Feb. 6, 2020

(30) Foreign Application Priority Data
Sep. 3, 2019 (KR) 10-2019-0108730

(51) Int. Cl. B60W 50/00; G01C 21/34; G06F 8/65

(52) U.S. Cl. CPC B60W 50/00; G01C 21/3415; B60W 2556/65; B60W 2050/0083; B60W 2050/0077; G06F 8/65

(57) ABSTRACT

A vehicle includes: a first communicator configured to communicate with at least one of a communication infrastructure or a moving vehicle; and a first controller configured to determine whether update for at least one electronic device included in the vehicle is required, and when the update for the at least one electric device is required, update the at least one electronic device on the basis of update information received from the moving vehicle or the communication infrastructure.

### CROSS-REFERENCE TO RELATED APPLICATION

This application claims priority to and the benefit of Korean Patent Application No. 10-2019-0108730, filed on Sep. 3, 2019, the entire contents of which are incorporated herein by reference.

### FIELD

The present disclosure relates to a vehicle and a method of controlling the same, and more specifically, to a vehicle including a plurality of antennas for communication and a method of controlling the same.

### BACKGROUND

The statements in this section merely provide background information related to the present disclosure and may not constitute prior art.

Vehicles do not only serve as a transportation device but also become a living space providing drivers with rest. In order to provide drivers with various convenience functions of comfort and rest as well as travel-related functions, various electronic devices are installed in the vehicles.

Meanwhile, in order for a vehicle to provide various latest functions, various electronic devices installed in the vehicle need to be updated. In particular, as wireless update is increasingly required, and various functions provided by the vehicle are advanced, data volume required for the update is increasing.

### SUMMARY

The present disclosure provides a vehicle capable of performing a communication (V2X) with an external device and a method of controlling the same.

Additional aspects of the disclosure will be set forth in part in the description which follows and, in part, will be obvious from the description, or may be learned by practice of the disclosure.

In an aspect of the present disclosure, a vehicle includes: a first communicator configured to communicate with at least one of a communication infrastructure or a moving vehicle; and a first controller configured to determine whether update for at least one electronic device included in the vehicle is required; and when the update for the at least one electric device is required, update the at least one electronic device on the basis of update information received from the moving vehicle or the communication infrastructure.

The first controller may determine whether to switch a travelling route of the vehicle based on at least one of device information of the at least one electronic device or route information of the moving vehicle.

The device information may include at least one of: a type of an update file required for updating the at least one electronic device; a size of the update file; a cumulative reception rate of the update file; or an importance of the update.

When it is determined that the travelling route is to be switched, the first controller may determine an optimal route on the basis of the at least one of the device information or the route information of the moving vehicle, and switch the travelling route on the basis of the determined optimal route.

In one form, the first controller may determine a target vehicle among a plurality of moving vehicles located in a predetermined area, and determine the optimal route on the basis of route information of the target vehicle.

In another form, the first controller may determine, among the plurality of moving vehicles, a moving vehicle having route information that is the most similar to the traveling route of the vehicle as the target vehicle.

The vehicle may further include a first input device configured to receive a degree of importance on the update from a user.

The first controller may control the first communicator to transmit a signal for requesting the update information to the moving vehicle or the communication infrastructure if the update for the at least one electronic device is desired.

The first controller may control the first communicator to transmit a signal for requesting the update information to the moving vehicle or the communication infrastructure if the update for the at least one electronic device is not completed.

The vehicle may further include a first storage, wherein the first controller may store the update information received from the moving vehicle or the communication infrastructure in the first storage.

The first controller may determine an update order of the at least one electronic device on the basis of the device information of the at least one electronic device, and update the at least one electronic device on the basis of the determined update order.

In another form of the present disclosure, a vehicle includes: a driver configured to generate power for travelling; a communicator configured to communicate with at least one of a communication infrastructure or a neighboring vehicle; and a controller configured to control the driver to travel on the basis of predetermined route information and control the communicator to transmit update information for updating at least one electronic device received from the communication infrastructure to the neighboring vehicle.

The vehicle may further include a storage configured to store the predetermined route information. In particular, the controller may control the communicator to transmit the predetermined route information to the neighboring vehicle located within a predetermined range.

In one form, the controller may control the communicator to transmit the predetermined route information together with the update information to the neighboring vehicle located within the predetermined range.

In another form, the controller may control the communicator to transmit the update information in response to a signal requesting for the update information.

In another object of the present disclosure, a method of controlling a vehicle may include: communicating, by a communicator, with at least one of a communication infrastructure or a moving vehicle; determining, by a controller, whether update for at least one electronic device included in a vehicle is required; and updating, by the controller, the at least one electronic device on the basis of update information received from the moving vehicle or the communication infrastructure if the update for the at least one electric device is required.

The determining of whether update for the at least one electronic device may include: determining whether update for the at least one electronic device is required, upon receiving the update information from the moving vehicle or the communication infrastructure.

The method may further include determining, by the controller, whether to switch a travelling route of the vehicle based on at least one of device information of the at least one electronic device, or route information of the moving vehicle.

The method may further include, when it is determined that the travelling route is to be switched, determining, by the controller, an optimal route based on the at least one of the device information or the route information of the moving vehicle, and switching the travelling route of the vehicle based on the determined optimal route.

The method may further include transmitting, by the communicator, a signal for requesting the update information to the moving vehicle or the communication infrastructure when the update for the at least one electronic device is required or the update for the at least one electronic device is not completed.

In another aspect of the present disclosure, a communication system includes: a communication infrastructure configured to provide a communication service; a moving vehicle configured to travel based on predetermined route information and transmit update information received from the communication infrastructure to an outside of the moving vehicle; and a vehicle configured to determine whether update for at least one electronic device is required and when the update for the at least one electric device is required, update the at least one electronic device based on the update information received from the moving vehicle.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a diagram illustrating a vehicle communicating with a moving vehicle and a communication infrastructure;

FIG. 2 illustrates a control block diagram of a vehicle;

FIG. 3 illustrates a control block diagram of a moving vehicle;

FIG. 4 is a diagram for describing the effects of a communication method of a vehicle;

FIG. 5 is a flowchart showing a method of controlling a vehicle; and

FIG. 6 is a flowchart showing a method of controlling a vehicle.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Like numerals refer to like elements throughout the specification. Not all elements of forms of the present disclosure will be described, and description of what are commonly known in the art or what overlap each other in the forms will be omitted. The terms as used throughout the specification, such as “˜ part”, “˜ module”, “˜ member”, “˜ block”, etc., may be implemented in software and/or hardware, and a plurality of “˜ parts”, “˜ modules”, “˜ members”, or “˜ blocks” may be implemented in a single element, or a single “˜ part”, “˜ module”, “˜ member”, or “˜ block” may include a plurality of elements.

It will be further understood that the term “connect” or its derivatives refer both to direct and indirect connection, and the indirect connection includes a connection over a wireless communication network.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements,

Although the terms “first,” “second,” “A,” “B,” etc. may be used to describe various components, the terms do not limit the corresponding components, but are used only for the purpose of distinguishing one component from another component.

As used herein, the singular forms “a,” “an” and “the” are intended to include the plural forms as well, unless the context clearly indicates otherwise.

Reference numerals used for method steps are just used for convenience of explanation, but not to limit an order of the steps. Thus, unless the context clearly dictates otherwise, the written order may be practiced otherwise.

Hereinafter, the principles and forms of the disclosure will be described with reference to the accompanying drawings.

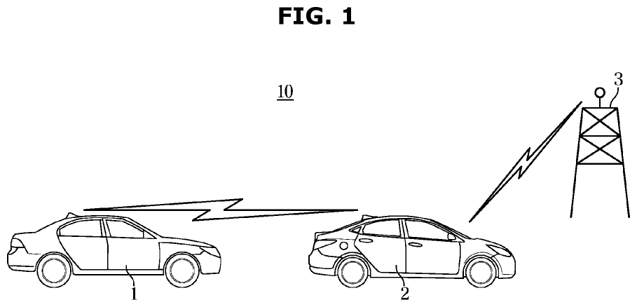

FIG. 1 is a diagram illustrating a communication system 10 according to one form of the present disclosure.

Referring to FIG. 1, the communication system 10 includes a vehicle 1, a moving vehicle 2, and a communication infrastructure 3.

The vehicle 1 may communicate with the moving vehicle 2 and the communication infrastructure 3.

The vehicle 1 may communicate with external devices for various purposes. For example, the vehicle 1 may communicate with the communication infrastructure 3 or the moving vehicle 2 to update software of electronic devices provided in the vehicle 1.

In this case, the vehicle 1 may receive, from the communication infrastructure 3 or the moving vehicle 2, update information required for updating software of at least one electronic device provided in the vehicle 1. In this case, the update information may refer to information required for updating the software of the electronic device, and may include an update file.

The communication infrastructure 3 may provide the vehicle 1 with a communication service. The communication infrastructure 3 may serve as a communication relay device that relays communication between the vehicle 1 and an external device such that the vehicle 1 communicates with the external device. For example, the communication infrastructure 3 may be a base station, an access point (AP), or the like.

In addition, the communication infrastructure 3 may provide the vehicle 1 with traffic information, and may receive traffic information from the vehicle 1 or the moving vehicle 2. In this case, the communication infrastructure 3 serves as a communication relay device that relays a communication between a traffic information server and the vehicle 1 or the moving vehicle 2 such that the vehicle 1 or the moving vehicle 2 communicates with the traffic information server.

The moving vehicle 2 may communicate with the communication infrastructure 3 or the vehicle 1. The moving vehicle 2 may receive update information required for update from the communication infrastructure 3, and the update information may include information for updating the moving vehicle 2 itself or information for updating the vehicle 1.

The moving vehicle 2 may transmit information received from the communication infrastructure 3 to the vehicle 1, and may transmit a signal received from the vehicle 1 to the communication infrastructure 3. In other words, the moving vehicle 2 may serve as a mobile repeater.

In addition, the moving vehicle 2 may travel on a predetermined route. The moving vehicle 2 may perform autonomous driving on the basis of predetermined route information. In this case, the route information of the moving vehicle 2 may be stored in advance and may be received from the communication infrastructure 3.

The moving vehicle 2 may refer to an autonomous vehicle that operates based on a service provided from the communication infrastructure 3. For example, the moving vehicle 2 may be an autonomous vehicle based on mobility as a service (MAAS).

The vehicle 1 may exchange data with a communication device of the moving vehicle 2 by targeting the moving vehicle 2. For example, the driver may exchange various types of information, such as traffic information, route information, update information, and the like with the moving vehicle 2 using a communication device of the vehicle 1.

In addition, the vehicle 1 may communicate with other devices in a multihop scheme using the moving vehicle 2. For example, when the vehicle 1 is out of a communication range, the vehicle 1 may exchange data with the communication infrastructure 3 via the moving vehicle 2. In addition, the vehicle 1 may receive traffic information from the communication infrastructure 3 via the moving vehicle 2.

The vehicle 1 may communicate with the communication infrastructure 3 or the moving vehicle 2 in various communication schemes. For example, the vehicle 1 may communicate with the infrastructure 3 or with the moving vehicle 2 using time division multiple access (TDMA), code division multiple access (CDMA), wideband code division multiple access (WCDMA), code division multiple access 2000 (CDMA2000), wireless broadband (Wibro), world interoperability for microwave access (WiMAX), long term evolution (LTE), or Wi-Fi evolution.

In particular, the vehicle 1 may communicate with the communication infrastructure 3 or the moving vehicle 2 using vehicle-to-everything (V2X) communication.

For example, the vehicle 1 may acquire various types of information, such as traffic information of a road, update information, and the like through communication with the communication infrastructure 3 (vehicle to infra communication: V2I), and may acquire various types of information, such as travelling information of another vehicle as well as traffic information and update information, through communication with the other vehicles (vehicle to vehicle communication: V2V).

The vehicle 1 may be provided with a separate V2X antenna (not shown) to communicate with the communication infrastructure 3 or the moving vehicle 2 using V2X communication. For example, the V2X antenna (not shown) may be installed at the rear of the roof of the vehicle 1 and may be installed near the front seats, such as on a head unit or a console box.

On the other hand, V2X communication may use a radio signal in a frequency band of about 5855 to 5895 MHz and a radio signal in a frequency band of about 5895 to 5925 MHz.

By using the V2X communication, the vehicle 1, the moving vehicle 2, and the communication infrastructure 3 may transmit and receive update information for updating the vehicle 1.

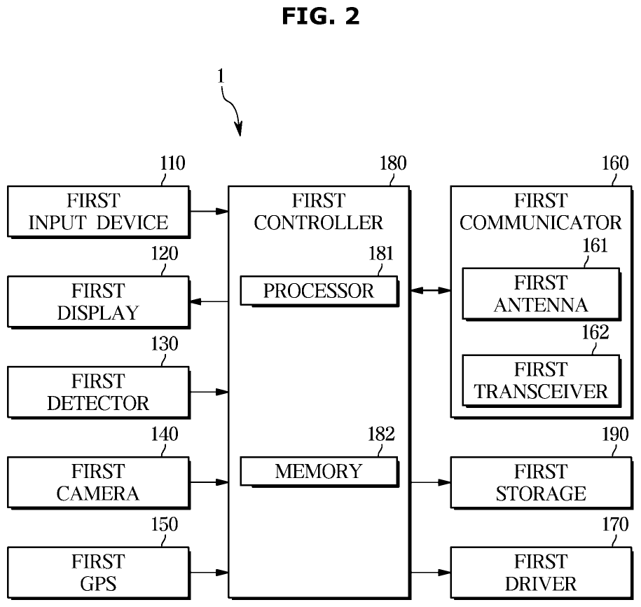

FIG. 2 illustrates a control block diagram of a vehicle according to one form of the present disclosure.

Referring to FIG. 2, the vehicle 1 may include a first input device 110, a first display 120, a first detector 130, a first camera 140, and a first GPS 150, a first communicator 160, a first driver 170, a first controller 180, and a first storage 190.

The first input device 110 may receive an input related to traveling and communication of the vehicle 1 from the driver. For example, the first input device 110 may receive a request for software update of the vehicle 1 or a request for traffic information from the driver.

The first input device 110 may include a plurality of switches for receiving a driver's input. In addition, the first input device 110 may include a push switch and a membrane switch operated by a user's pressing manipulation, or a touch switch operated by a contact of a part of a user's body.

The first display 120 may display information regarding traveling and communication of the vehicle 1 to the driver. The first display 120 may display, for example, information regarding an update progress status of software of at least one electronic device, information regarding an electronic device that requires update, and the like. In addition, the first display 120 may display travelling related information, such as traffic information of surrounding roads, received through the V2X communication.

The first display 120 may include various types of display panels for displaying information regarding traveling and communication of the vehicle 1. For example, the first display 120 may include a light emitting diode (LED) panel, an organic light emitting diode (OLED) panel, a liquid crystal display (LCD) panel, or the like.

In addition, the first display 120 may adopt a touch screen panel (TSP) that receives an input from a driver and displays operation information corresponding to the received control command.

The touch screen panel includes a display for displaying operation information and/or a control command, a touch panel for detecting coordinates of a contact with a part of the user's body, and a touch screen controller for determining a control command input by a user on the basis of the touch coordinates detected by the touch panel. The touch screen controller may recognize the control command input by the user by comparing the touch coordinates of the user detected through the touch panel with coordinates of the control command displayed on the display.

The first detector 130 detects state information of the vehicle 1.

The first detector 130 includes at least one of an angular velocity detector for detecting an angular velocity of a steering wheel for detecting a steering angle of the vehicle 1, a velocity detector for detecting a traveling velocity of the vehicle 1, a yaw moment detector for detecting a yaw moment of the vehicle 1, or an acceleration detector for detecting the acceleration of the vehicle 1.

To this end, the first detector 130 may include at least one of an acceleration sensor, a light detection and ranging (LiDAR) sensor, an ultrasonic sensor, or a laser radar (LADAR) sensor.

The first camera 140 may acquire an image of the surroundings of the vehicle 1 and transmit the acquired image to the first controller 180.

The first camera 140 detects information about objects around the vehicle 1 and converts the object information into an electrical image signal. The first camera 140 detects an external environment of a host vehicle at the current location of the host vehicle, i.e., information about a road on which the host vehicle is travelled and objects located on the front and the left and right sides of the host vehicle, and transmits an image signal corresponding to the detected object information to the first controller 180.

To this end, the first camera 140 may include a charge-coupled device (CCD) or complementary metal-oxide semiconductor (CMOS) image sensor.

The first GPS 150 may acquire current location information of the vehicle by receiving location information provided from a plurality of satellites. The first GPS 150 may include an antenna for receiving signals of a plurality of GPS satellites, software for acquiring the location of the vehicle using distance and time information corresponding to location signals of the plurality of GPS satellites, and an outputter for outputting the acquired current location information.

The first communicator 160 may communicate with at least one of the moving vehicle 2 or the communication infrastructure 3. The first communicator 160 may transmit a communication signal received from at least one of the moving vehicle 2 or the communications infrastructure 3 to the first controller 180. The first communicator 160 may transmit a communication signal corresponding to the state information, the detection information, and the user input information of the vehicle 1 to the moving vehicle 2, a neighboring vehicle, or the communication infrastructures 3 on the basis of a control command of the first controller 180.

The first communicator 160 may include a first antenna 161 and a first transceiver 162. The first antenna 161 and the first transceiver 162 may transmit and receive wireless communication signals, for example, may transmit and receive V2X wireless communication signals.

The first communicator 160 may receive update information required for updating various electronic devices included in the vehicle 1 from at least one of the moving vehicle 2 or the communication infrastructure 3. In this case, the first communicator 160 may receive the update information in a single scheme or a diversity scheme.

When the first communicator 160 receives the update information in a diversity scheme, the second antenna 261 may include a plurality of antennas. For example, the second antenna 261 may include a plurality of V2X antennas spaced apart from each other. When the same radio waves are received at two points sufficiently distant from each other, the radio waves being reflected from a reflector, such as a building, reach by propagating in different routes, and such a difference in propagation route causes interference therebetween, leading to fading. In this case, the fading state of the received radio waves is varied depending on the reception position. Accordingly, the influence of the fading of the signals may be reduced by appropriately combining or selecting signals received at the different positions.

Meanwhile, the first communicator 160 may include one or more components that enable communication with an external device, for example, at least one of a short-range communication module, a wired communication module, or a wireless communication module.

The short-range communication module may include various short-range communication modules that transmit and receive signals using a wireless communication network in a short range, such as a Bluetooth module, an infrared communication module, a radio frequency identification (RFID) communication module, a wireless local access network (WLAN) communication module, an NFC communication module, and a zigbee communication module.

The wired communication module may include various wired communication modules, such as a controller area network (CAN) communication module, a local area network (LAN) module, a wide area network (WAN) module, or a value added network communication (VAN) module, and various cable communication modules, such as a universal serial bus (USB) module, a high definition multimedia interface (HDMI) module a digital visual interface (DVI) module, a recommended standard-232 (RS-232) module, a power line communication module, or a plain old telephone service (POTS) module.

The wireless communication module may include wireless communication modules supporting various wireless communication methods, such as a Wifi module, a wireless broadband module (Wibro) module, a global system for mobile communication (GSM) module, a code division multiple access (CDMA) module, a wideband code division multiple access (WCDMA) module, a universal mobile telecommunications system (UMTS) module, a time division multiple access (TDMA) module, a long term evolution (LTE) module, and the like.

The first driver 170 is a device for driving the vehicle 1, and may include a braking device, a suspension device, a power generating device, a power transmission device, and a steering device.

The first storage 190 may store information received from the moving vehicle 2 or the communication infrastructure 3. The first storage 190 may store data packets transmitted in real time from the moving vehicle 2 or the communication infrastructure 3.

In addition, the first storage 190 may store various types of information regarding the vehicle 1, such as a travelling route.

To this end, the first storage 190 may include a buffer.

Meanwhile, the first storage 190 may include a nonvolatile memory device, such as a cache, a read only memory (ROM), a programmable ROM (PROM), an erasable programmable ROM (EPROM), an electrically erasable programmable ROM (EEPROM), and a flash memory, a volatile memory device, such as a random access memory (RAM), or other storage media, such as a hard disk drive (HDD), a CD-ROM, and the like, but the implementation of the first storage 190 is not limited thereto. The first storage 190 may be a memory implemented as a chip separated from a processor 181, which will be described below in connection with the first controller 180, or may be implemented as a single chip integrated with the processor 181.

The first controller 180 includes a memory 182 for storing programs and data for controlling travelling and/or communication of the vehicle 1 and the processor 181 that generates a signal for controlling the traveling and/or communication of the vehicle 1 on the basis of the programs and data stored in the memory 182.

The memory 182 may include a volatile memory, such as an S-RAM, a D-RAM, and the like, and a non-volatile memory, such as a flash memory, a read only memory (ROM), an erasable programmable read only memory (EPROM), and the like.

The processor 181 may include a main processor that controls travelling of the vehicle 1, a communication processor that controls communication of the vehicle 1, an image processor that processes an image of the first camera 140, and the like.

The first controller 180 is provided in the vehicle 1, and controls the various drivers 170 and an additional device provided in the vehicle 1. The first controller 180 may include a controller provided in an autonomous driving control device for autonomous driving.

The first controller 180 may control autonomous driving of the vehicle 1 on the basis of user input information of the first input device 110, image information of the first camera 140, detection information of the first detector 130, location information of the first GPS 150, and information received through the first communicator 160.

The first controller 180 may determine an update for at least one electronic device included in the vehicle 1 is required. In this case, the update for the electronic device refers to an update for software of the electronic device.

In detail, the first controller 180 may check the software versions of various electronic devices including the first input device 110, the first display 120, the first detector 130, the first camera 140, the first GPS 150, the first driver 170, the first communicator 160, and the like, and if the checked version is not the latest version, it is determined that software update is required.

The electronic devices are not limited to the above components, and may include all types of components capable of providing convenience functions to a user, for example, an audio-video-navigation (AVN) device or an autonomous driving device, such as an advanced driver-assistance system (ADAS) device.

When an update for at least one electronic device is required, the first controller 180 may perform update on the at least one electronic device on the basis of received update information.

In this case, when update information is not received, the first controller 180 may control the first communicator 160 to receive update information for updating the electronic device from the moving vehicle 2 or the communication infrastructure 3.

In detail, the first controller 180 may control the first communicator 160 to transmit a request signal for requesting update information to the moving vehicle 2 or the communication infrastructure 3. When the update information corresponding to the request signal is received from the moving vehicle 2 or the communication infrastructure 3, the first controller 180 may perform an update on the electronic device on the basis of the received update information.

In one form, when the update information for updating the electronic device is received from the moving vehicle 2 or the communication infrastructure 3, the first controller 180 may perform an update on the electronic device on the basis of whether update for at least one electronic device included in the vehicle 1 is required.

In this case, when the first controller 180 receives the update information from the moving vehicle 2 or the communication infrastructure 3 without requesting the update information, the first controller 180 may determine whether an update for the electronic device is required. If it is determined that an update for the electronic device is required, the first controller 180 may update the electronic device on the basis of the received update information.

Meanwhile, with regard to receiving the update information from the moving vehicle 2 or the communication infrastructure 3, the first controller 180 may store the update information received in real time in the first storage 190.

While the update information is being received from the moving vehicle 2 or the communication infrastructure 3, communication disconnection may occur due to a change in the communication environment.

In this case, the first controller 180 may store only the update information having been received until the communication is disconnected in the first storage 190. Thereafter, the first controller 180 may continue receiving the update information from another moving vehicle 2 or the communication infrastructure 3, and store the update information in the first storage 190. Such a reception method is referred to a cumulative method.

In addition, the first controller 180 may control the first communicator 160 to receive update information in a single scheme or a diversity scheme according to the electric field situation. When the signal electric field is smooth, that is, when the communication is connected to both the moving vehicle 2 and the communication infrastructure 3, the first controller 180 may control the first communicator 160 to receive the update information in a diversity scheme.

Alternatively, when the communication is connected to any one of the moving vehicle 2 and the communication infrastructure 3, the first controller 180 may control the first communicator 160 to receive the update information in a single scheme. In this case, the first communicator 160 may receive the update information from the moving vehicle 2 or the communication infrastructure 3.

With regard to performing the update for the electronic device, the first controller 180 may determine the update order on the basis of device information of at least one device, and update the electronic device on the basis of the update order.

In this case, the device information refers to information required for performing an update on the electronic device, and includes at least one of a type of an update file required for performing an update on at least one electronic device, a size of the update file, a cumulative reception rate of the update file, or an importance of the update.

The importance of the update may be determined according to a predetermined priority or on the basis of a priority input by the user through the first input device 110.

For example, when a plurality of update files required for performing an update for the electronic device exist, the first controller 180 may determine an update order for the plurality of update files. The first controller 180 may determine the priority on the basis of at least one of the cumulative reception rate of the update file or the importance of the update. The first controller 180 may perform the update on the basis of the determined priority.

In this case, the first controller 180 may update the electronic device while the update information is being received. However, the present disclosure is not limited thereto, and the first controller 180 may update the electronic device after all the update information is received.

When the update for the electronic device is required, the first controller 180 may determine whether to switch the traveling route on the basis of at least one of device information of the electronic device or route information of the moving vehicle 2.

In this case, the device information refers to information required for performing an update on the electronic device, and may include at least one of a type of an update file required for performing an update on the electronic device, a size of the update file, a cumulative reception rate of the update file, or an importance of the update. The route information of the moving vehicle 2 may be received from the moving vehicle 2 or may be stored in the first storage 190 in advance.

In detail, the first controller 180 may determine whether to switch the travelling route on the basis of the route information of the moving vehicle 2 which transmits update information having a higher importance.

For example, in a state in which the importance of the update for device-A is given the first priority, and the importance of the update for device-B is given the second priority, if the route information of the moving vehicle 2 that transmits update information for updating the device-A matches the travelling route at a rate equal to or greater than a predetermined reference value, the first controller 180 may determine not to switch the travelling route. That is, the first controller 180 may determine to maintain the travelling route.

If the route information of the moving vehicle 2 that transmits update information for updating the device-A matches the travelling route at a rate less than the predetermined reference value, the first controller 180 may determine to switch the travelling route.

If it is determined that the travelling route is not to be switched, the first controller 180 may maintain the existing route and receive update information from the moving vehicle 2 or the communication infrastructure 3, and update the electronic device that needs to be updated.

If it is determined that the travelling route is to be switched, the first controller 180 determines an optimal route on the basis of at least one of the device information of the vehicle 1 or the route information of the moving vehicle 2, and provides the user with the determined optimal route.

In this case, the optimal route may refer to a route capable of maintaining communication for updating the electronic device, and may refer to a route capable of maintaining communication with the moving vehicle 2 or the communication infrastructure 3 for a predetermined time.

To this end, the first controller 180 may determine a target vehicle among the moving vehicles 2 located within a predetermined area from the vehicle 1 and determine an optimal route on the basis of route information of the target vehicle.

In detail, the first controller 180 may determine a moving vehicle 2 among the at least one moving vehicle 2 within a predetermined area from the vehicle 1, which has route information similar to the travelling route of the vehicle 1 at a degree equal to or greater than a predetermined value, as a target vehicle, and may determine the optimal route on the basis of the route information of the target vehicle.

In another form, the first controller 180 may determine a moving vehicle 2 having route information that is the most similar to the travelling route of the vehicle 1 among the at least one moving vehicle 2 within a predetermined area from the vehicle 1 as a target vehicle, and may determine the optimal route on the basis of route information of the target vehicle.

To this end, the first controller 180 may receive route information from a respective moving vehicle of the at least one moving vehicle 2 located in the predetermined area from the vehicle 1. The route information of each moving vehicle 2 may be received together with the update information.

The first controller 180 may provide the user with the determined optimal route through the first display 120 such that the user travels in the optimal route.

In other form, the first controller 180 may control the first driver 170 to switch the travelling route to the determined optimal route, and perform autonomous driving on the basis of the optimal route. In this case, the travelling route is automatically switched to the optimal route, and the vehicle 1 may travel on the optimal route.

Since the communication with the moving vehicle 2 or the communication infrastructure 3 is maintained during the travelling according to the optimal route, the first controller 180 may receive the update information from the moving vehicle 2 or the communication infrastructure 3, and update the electronic device on the basis of the received update information.

With this configuration, the first controller 180 may reliably receive update information from the moving vehicle 2 or the communication infrastructure 3, and efficiently update the electronic device.

In addition, the first controller 180 may check whether the update for the electronic device is completed, and if the update for the electronic device is not completed, may control the first communicator 160 to transmit a signal for requesting the update information to the moving vehicle 2 or the communication infrastructure 3.

In this case, the first controller 180 may transmit the signal for requesting the update information to the moving vehicle 2 located in a predetermined area or the communication infrastructure 3. When the update information is received in response to the request signal, the first controller 180 may continue updating the electronic device.

Accordingly, the wireless update is efficiently performed regardless of the communication area, so that the user convenience is increased.

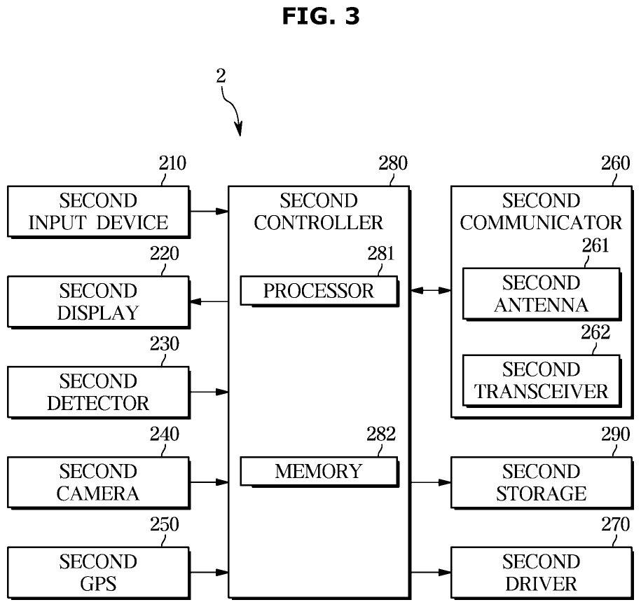

FIG. 3 illustrates a control block diagram of the moving vehicle 2 according to one form of the present disclosure.

Referring to FIG. 3, the mobile vehicle 2 may include a second input device 210, a second display 220, a second detector 230, a second camera 240, and a second GPS 250, a second communicator 260, a second driver 270, a second controller 280, and a second storage 290.

The second input device 220, the second display 220, the second detector 230, the second camera 240, the second GPS 250, and the second driver 270 are similar to the components described with reference to FIG. 2, and thus the descriptions of the first input device 110, the first display 120, the first detector 130, the first camera 140, the first GPS 150, and the first driver 170 are applied thereto.

The second communicator 260 may communicate with at least one of the vehicle 1 or the communication infrastructure 3.

The second communicator 260 may include a second antenna 261 and a second transceiver 262. The second antenna 261 and the second transceiver 262 may transmit and receive a wireless communication signal, for example, a V2X wireless communication signal.

The second communicator 260 may receive update information required for updating various electronic devices included in the vehicle 1 from the communication infrastructure 3.

Meanwhile, the second communicator 260 may include one or more components that enable communication with an external device, for example, at least one of a short-range communication module, a wired communication module, and a wireless communication module. The description of the second communicator 260 is the same as described above.

The second storage 290 may store information received from the vehicle 1 or the communication infrastructure 3 as well as information of the moving vehicle 2.

The second storage 290 may store route information of the moving vehicle 2. In this case, the route information refers to information about a traveling route of the moving vehicle 2. The route information may be received from the communication infrastructure 3 or may be stored in advance at a time of design.

The second storage 290 may be implemented as at least one of a nonvolatile memory device, a volatile memory device, or a storage medium, but the implementation is not limited thereto. The description of the second storage 290 is the same as that of the first storage 190. The second storage 290 may be a memory implemented as a chip separated from a processor 281 which will be described below with respect to the second controller 280, or may be implemented as a single chip integrated with the processor 281.

The second controller 280 include a memory 282 storing programs and data for controlling travelling and/or communication of the moving vehicle 2 and the processor 281 that generates a signal for controlling the traveling and/or communication of the moving vehicle 2 on the basis of the programs and data stored in the memory 282.

The memory 282 may not only include a volatile memory device, such as a SRAM and a D-RAM, but also include a nonvolatile memory device, such as a flash memory, a read only memory (ROM), an erasable programmable ROM (EPROM), and the like.

The processor 281 may include a main processor that controls travelling of the moving vehicle 2, a communication processor that controls communication of the moving vehicle 2, an image processor that processes an image of the second camera 240, and the like.

The second controller 280 is provided in the moving vehicle 2, and controls various drivers 270 and additional devices provided in the moving vehicle 2. The second controller 280 may represent a controller provided in an autonomous driving control device for autonomous driving.

The second controller 280 may control autonomous driving of the moving vehicle 2 on the basis of image information of the second camera 240, detection information of the second detector 230, location information of the second GPS 250, and information received through the second communicator 260.

The second controller 280 may control the second driver 270 to travel on the basis of predetermined route information.

The second controller 280 may control the second communicator 260 to transmit update information for updating at least one electronic device received from the communication infrastructure 3 to an external device.

The second controller 280 may transmit the update information to a neighboring vehicle located within a predetermined range. In this case, the predetermined range may refer to a range in which V2X communication is performable, and the neighboring vehicle may include at least one of other moving vehicles 2 or the vehicle 1.

The second controller 280 may control the second communicator 260 to transmit the update information to at least one neighboring vehicle located within the predetermined range while travelling on the basis of the predetermined route information.

In this case, the second controller 280 may transmit the route information along with the update information to vehicles located within the predetermined range.

In one form, the second controller 280 may control the second communicator 260 to transmit the update information to the vehicle 1 in response to receiving a request signal for the update information from the vehicle 1.

As such, the second controller 280 may serve as a relay between the communication infrastructure 3 and the neighboring vehicle by transmitting the update information received from the communication infrastructure 3 or stored in advance. With this configuration, even when the neighboring vehicle does not receive update information from the communication infrastructure 3, the neighboring vehicle may receive the update information if the neighboring vehicle is within a predetermined range from the travel route of the moving vehicle 2. Accordingly, the update efficiency of the neighboring vehicle may be increased, and the user convenience may also be increased.

In addition, the second controller 280 may transmit traffic information to the communication infrastructure 3 while traveling on the basis of the predetermined route information. In this case, the traffic information may refer to information with which a traffic environment is estimated, and may include information regarding traffic accidents, traffic conditions, and the like.

To this end, the second controller 280 may generate the traffic information on the basis of data acquired by the second detector 230, the second camera 240, or the second GPS 250. Alternatively, the second controller 280 may acquire the traffic information by receiving the traffic information generated by the first detector 130, the first camera 140, or the first GPS 150 of the vehicle 1 from the vehicle 1.

With this configuration, immediate update of traffic situation information may be performed, and the communication infrastructure 3 may provide traffic information suitable for a real-time traffic situation.

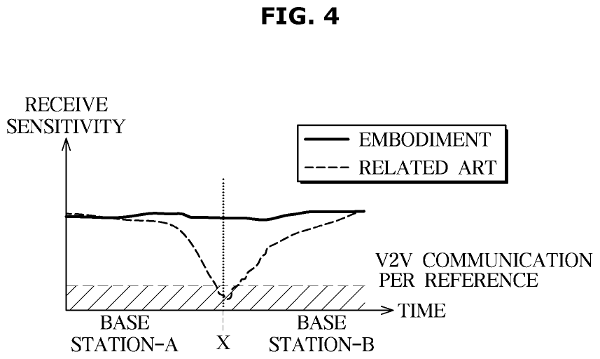

FIG. 4 is a diagram for describing the effects of a communication method of a vehicle according to one form of the present disclosure.

The receive sensitivity according to the conventional communication method generally decreases as the distance from the center of a communication infrastructure increases.

Referring to FIG. 4, according to the conventional communication method, the receive sensitivity decreases as the distance from the center of a communication cell of a base station-A decreases, and the receive sensitivity decreases as the distance from the center of a communication cell of a base station-B increases.

Accordingly, the receive sensitivity of an area X distant from the centers of the base station-A and the base station-B may be lower than a V2V communication packet error rate (PER) reference receive sensitivity. In this case, a V2V communication failure may occur.

However, with the communication method of the vehicle 1 according to one form of the form, the moving vehicle 2 traveling along a predetermined route serves as a repeater, so that the receive sensitivity of the area X distant from the centers of the base stations A and B may have a value greater than the V2V communication PER reference receive sensitivity.

That is, even when the vehicle 1 is located in the area X distant from the centers of the base stations A and B, the vehicle 1 communicates with the base station-A or the base station-B via the moving vehicle 2 located in the base station-A or the base station-B.

As such, V2V communication is maintained regardless of the location of the base station, so that the efficiency of the communication may be increased. At the same time, since the V2V communication is smoothly maintained, the user convenience may be increased in providing a convenience function using the V2V communication.

In addition, since the wireless update for the vehicle 1 is efficiently performed in the city area and the suburb area, the user satisfaction is improved by providing the latest functions.

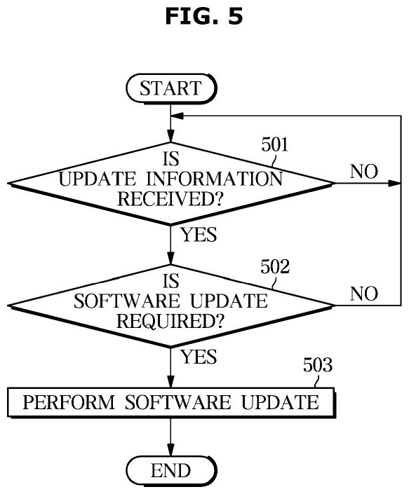

FIG. 5 is a flowchart showing a method of controlling a vehicle according to one form of the present disclosure.

Referring to FIG. 5, the vehicle 1 may determine whether update information is received from the moving vehicle 2 located in a surrounding of the vehicle 1 or the communication infrastructure 3 (501). In this case, the update information may refer to information required for updating software of the electronic device, and may include an update file. The moving vehicle 2 may refer to an autonomous vehicle operating based on a service provided from the communication infrastructure 3. For example, the moving vehicle 2 may be an autonomous vehicle based on MAAS.

Upon receiving the update information (Yes in operation 501), the vehicle 1 may determine whether software update is required (502). In detail, the vehicle 1 may determine whether software update for at least one electronic device installed in the vehicle 1 is required. The vehicle 1 may check the version of software of various electronic devices installed in the vehicle 1, and if the checked version is not the latest version, determine that a software update is required.

If a software update for at least one electronic device is required (YES in operation 502), the vehicle 1 may perform a software update on the basis of the received update information (503).

In order to perform the software update, the vehicle 1 may determine an update order on the basis of device information of the at least one device, and update the electronic device on the basis of the update order.

In this case, the device information refers to information required for performing an update on the electronic device, and includes at least one of a type of an update file required for performing an update on at least one electronic device, a size of the update file, a cumulative reception rate of the update file, or an importance of the update. The importance of the update may be determined according to a predetermined priority or on the basis of a priority input by the user through the first input device 110.

For example, when a plurality of update files required for performing an update for the electronic device exist, the vehicle 1 may determine an update order for the plurality of update files. The vehicle 1 may determine the priority on the basis of at least one of the cumulative reception rate of the update file or the importance of the update. The vehicle 1 may perform the update on the basis of the determined priority.

With this configuration, since the vehicle 1 performs the update using the update information received from the moving vehicle 2 or the communication infrastructure 3, the wireless update may be efficiently performed regardless of the communication area. Accordingly, the user convenience may be increased.

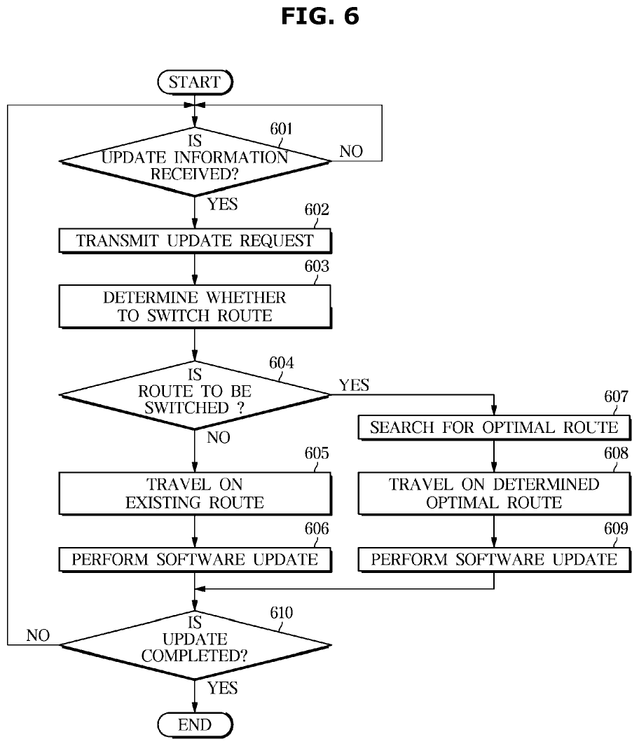

FIG. 6 is a flowchart showing a method of controlling a vehicle according to another form of the present disclosure.

Referring to FIG. 6, the vehicle 1 may determine whether software update for at least one electronic device in the vehicle 1 is required (601). In this case, the vehicle 1 may check whether software update for the electronic device is required on the basis of a predetermined cycle regardless of whether update information is received.

If software update is required (Yes in operation 601), the vehicle 1 may transmit an update request to the moving vehicle 2 located in a surrounding of the vehicle 1 or the communication infrastructure 3 (602). In detail, the vehicle 1 may perform an update request by transmitting a signal for requesting update information for the electronic device that requires update to the moving vehicle 2 or the communication infrastructure 3. In this case, the vehicle 1 may transmit the signal for requesting the update information to the moving vehicle 2 located in a predetermined area or the communication infrastructure 3.

The vehicle 1 may determine whether to switch a route on the basis of at least one of device information of the electronic device or route information of the moving vehicle 2 (603).

In this case, the device information refers to information required for performing an update on the electronic device, and includes at least one of a type of an update file required for performing an update on the electronic device, a size of the update file, a cumulative reception rate of the update file, or an importance of the update. The route information of the moving vehicle 2 may be received from the moving vehicle 2 or may be stored in advance in the vehicle 1.

In detail, the vehicle 1 may determine switching of the travelling route on the basis of route information of the moving vehicle 2 that transmits update information having a higher importance.

For example, in a state in which the importance of the update for a device-A is given the first priority, and the importance of the update for a device-B is given the second priority, if the route information of the moving vehicle 2 that transmits update information for updating the device-A matches the travelling route at a rate equal to or greater than a predetermined reference value, the vehicle 1 may determine not to switch the travelling route. That is, the vehicle 1 may determine to maintain the travelling route.

If the route information of the moving vehicle 2 that transmits update information for updating the device-A matches the travelling route at a rate less than the predetermined reference value, the vehicle 1 may determine to switch the travelling route.

If it is determined that the route is to be switched (YES in operation 604), the vehicle 1 may search for the optimal route on the basis of at least one of the device information of the vehicle 1 or the route information of the moving vehicle 2 (607). In this case, the optimal route may refer to a route capable of maintaining communication for updating the electronic device, and may refer to a route capable of maintaining communication with the moving vehicle 2 or the communication infrastructure 3 for a predetermined time.

To this end, the vehicle 1 may determine a target vehicle among the moving vehicles 2 located within a predetermined area from the vehicle 1 and determine an optimal route on the basis of route information of the target vehicle.

In detail, the vehicle 1 may determine a moving vehicle 2 among the at least one moving vehicle 2 within a predetermined area from the vehicle 1, which has route information similar to the travelling route of the vehicle 1 at a degree equal to or greater than a predetermined value, as a target vehicle, and may determine the optimal route on the basis of the route information of the target vehicle.

In one form, the vehicle 1 may determine a moving vehicle 2 having route information that is the most similar to the travelling route of the vehicle 1 among the at least one moving vehicle 2 within a predetermined area from the vehicle 1 as a target vehicle, and may determine the optimal route on the basis of the route information of the target vehicle.

Thereafter, the vehicle 1 may travel on the determined optimal route (608), and may perform software update for at least one electronic device while travelling on the optimal route (609). In this case, since the communication with the moving vehicle 2 or the communication infrastructure 3 is maintained during the travel along the optimal route, the vehicle 1 may receive update information from the moving vehicle 2 or the communication infrastructure 3, and update the electronic device on the basis of the received update information.

With this configuration, the vehicle 1 may stably receive update information from the moving vehicle 2 or the communication infrastructure 3, and efficiently update the electronic device.

As another example, when it is determined that the travelling route is not to be switched (NO in operation 604), the vehicle 1 may travel on the existing route (605). By maintaining the existing route, the vehicle 1 may receive update information from the moving vehicle 2 or the communication infrastructure 3 and perform software update for the electronic device that needs to be updated (606).

After the software update (606 or 609), the vehicle 1 may check whether the update for the electronic device is completed (610), and if the update for the electronic device is not completed (NO in operation 610), operations 601 to 609 are repeated to continue the update for the electronic device.

Accordingly, the wireless update is efficiently performed regardless of the communication area, so that the user convenience is increased.

As is apparent from the above, the vehicle and the method of controlling came can increase the user convenience by efficiently updating an electronic device.

Although forms of the present disclosure have been described for illustrative purposes, those skilled in the art will appreciate that various modifications, additions and substitutions are possible, without departing from the scope and spirit of the disclosure. Therefore, forms of the present disclosure have not been described for limiting purposes.

What is claimed is:

1. A vehicle comprising:
a first communicator configured to communicate with at least one of a communication infrastructure or a moving vehicle; and
a first controller configured to:
determine whether update for at least one electronic device included in the vehicle is required, and
when the update for the at least one electric device is required, update the at least one electronic device based on update information received from the moving vehicle or the communication infrastructure.

2. The vehicle of claim 1, wherein the first controller is configured to determine whether to switch a travelling route of the vehicle based on at least one of device information of the at least one electronic device or route information of the moving vehicle.

3. The vehicle of claim 2, wherein the device information includes at least one of:
a type of an update file required for updating the at least one electronic device;
a size of the update file;
a cumulative reception rate of the update file; or
an importance of the update.

4. The vehicle of claim 3, further comprising: a first input device configured to receive a degree of the importance of the update from a user.

5. The vehicle of claim 2, wherein when switching the travelling route is determined, the first controller is configured to:
determine an optimal route based on the at least one of the device information or the route information of the moving vehicle, and
switch the travelling route based on the determined optimal route.

6. The vehicle of claim 5, wherein the first controller is configured to:
determine a target vehicle among a plurality of moving vehicles located in a predetermined area, and
determine the optimal route based on route information of the target vehicle.

7. The vehicle of claim 6, wherein the first controller is configured to determine, among the plurality of moving vehicles, a moving vehicle having route information that is the most similar to the traveling route of the vehicle as the target vehicle.

8. The vehicle of claim 1, wherein the first controller is configured to control the first communicator to transmit a signal for requesting the update information to the moving vehicle or the communication infrastructure when the update for the at least one electronic device is required.

9. The vehicle of claim 1, wherein the first controller is configured to control the first communicator to transmit a signal for requesting the update information to the moving vehicle or the communication infrastructure when the update for the at least one electronic device is not completed.

10. The vehicle of claim 1, further comprising a first storage,
wherein the first controller is configured to store the update information received from the moving vehicle or the communication infrastructure in a first storage.

11. The vehicle of claim 1, wherein the first controller is configured to:
determine an update order of the at least one electronic device based on the device information of the at least one electronic device, and
update the at least one electronic device based on the determined update order.

12. A vehicle comprising:
a driver configured to generate power for travelling;
a communicator configured to communicate with at least one of a communication infrastructure or a neighboring vehicle; and
a controller configured to:
control the driver to travel based on predetermined route information, and
control the communicator to transmit update information for updating at least one electronic device received from the communication infrastructure to the neighboring vehicle.

13. The vehicle of claim 12, further comprising: a storage configured to store the predetermined route information,
wherein the controller is configured to control the communicator to transmit the predetermined route information to the neighboring vehicle located within a predetermined range.

14. The vehicle of claim 13, wherein the controller is configured to control the communicator to transmit the predetermined route information together with the update information to the neighboring vehicle located within the predetermined range.

15. The vehicle of claim 12, wherein the controller is configured to control the communicator to transmit the update information in response to a signal requesting for the update information.

16. A method of controlling a vehicle, the method comprising:
communicating, by a communicator, with at least one of a communication infrastructure or a moving vehicle;
determining, by a controller, whether update for at least one electronic device included in a vehicle is required; and
updating, by the controller, the at least one electronic device based on update information received from the moving vehicle or the communication infrastructure when the update for the at least one electric device is required.

17. The method of claim 16, wherein determining whether update for the at least one electronic device includes:
determining whether update for the at least one electronic device is required, upon receiving the update information from the moving vehicle or the communication infrastructure.

18. The method of claim 16, further comprising: determining, by the controller, whether to switch a travelling route of the vehicle based on at least one of:
device information of the at least one electronic device, or
route information of the moving vehicle.

19. The method of claim 18, further comprising:
when it is determined that the travelling route is to be switched, determining, by the controller, an optimal route based on the at least one of the device information or the route information of the moving vehicle; and
switching the travelling route of the vehicle based on the determined optimal route.

20. The method of claim 16, further comprising:
transmitting, by the communicator, a signal for requesting the update information to the moving vehicle or the communication infrastructure when the update for the at least one electronic device is required or the update for the at least one electronic device is not completed.

21. A communication system comprising:
a communication infrastructure configured to provide a communication service;
a moving vehicle configured to travel based on predetermined route information and transmit update information received from the communication infrastructure to an outside of the moving vehicle; and
a vehicle configured to:
determine whether update for at least one electronic device is required, and
when the update for the at least one electric device is required, update the at least one electronic device based on the update information received from the moving vehicle.
